(19) United States
(12) Patent Application Publication
(10) Pub. No.: US 2017/0337448 A1
(43) Pub. Date: Nov. 23, 2017

(54) AUTOMATIC ELECTRIC GROUND SERVICE EQUIPMENT PARKING BAY MONITORING SYSTEM

(71) Applicant: Hong Kong Productivity Council, Hong Kong (HK)

(72) Inventors: Chiu Shing Ng, Hong Kong (HK); Wai Chung Lee, Hong Kong (HK); Tai Wai Li, Hong Kong (HK); Yuen Yee Chung, Hong Kong (HK); Shuk Ching Chan, Hong Kong (HK)

(21) Appl. No.: 15/451,402

(22) Filed: Mar. 6, 2017

(30) Foreign Application Priority Data
May 18, 2016 (HK) 16105726.2

(51) Int. Cl. G06K 9/62; G06T 7/11; G08G 1/14; H04L 29/08; G06N 3/08; B60L 11/18; G06K 9/00; G06K 9/46; G06T 3/00; H04N 7/18; G06T 7/174

(52) U.S. Cl. CPC G06K 9/628; H04N 7/183; G06T 7/11; G08G 1/144; H04L 67/02; G06T 7/174; B60L 11/1809; G06K 9/00771; G06K 9/4642; G06T 3/0025; G06N 3/084; G06K 9/6256; G06K 9/4652; G06T 2207/10024; G06T 2207/20081; G06T 2207/20084; G06T 2207/30232; G06T 2207/30261

(57) ABSTRACT

A parking bay monitoring system for electric vehicles includes a main unit for each parking bay, a router being housed in the main unit and connects to a network, at least one digital camera mounted in a position to take digital images of a parking bay, wherein the digital images are transmitted via the router to a central server for analysis by a visual recognition framework to generate a detection result. The system further includes a charging unit, wherein real time data relating to charging is logged and transmitted to the central server, wherein an occupancy status for each parking bay is generated based on the detection result and said data. The system generates a list containing the occupancy status of each parking bay and the said list being accessible by at least one terminal connected to the network.

### CROSS-REFERENCE TO RELATED APPLICATIONS

This application claims the benefit of Hong Kong Short-term Patent Application No. 16105726.2 filed on May 18, 2016, the contents of which are hereby incorporated by reference.

### FIELD OF THE INVENTION

This invention relates to the field of systems and methods for monitoring parking arrangements of ground service vehicles based on visual recognition and relevant collected data. More specifically, the present invention relates to a system for managing the charging and storing of electric vehicles used in facilities such as airports.

### BACKGROUND OF THE INVENTION

The difficulty of parking and storing ground service vehicles in orderly and efficient manner have long been a formidable issue in many modern airport facilities. With the rising trend of adopting zero-emission vehicles in replacement of vehicles with combustion engines, electric vehicles (EVs) or electric ground service equipment (EGSE) are widely used in the airports as ground service vehicles often in a large quantity. EVs or EGSEs (will be referred as EVs hereinafter), while often cleaner to operate and service, are typically limited by their battery storage capacities. EVs are so designed and configured that they can be recharged on site via multiple charging stations. Since there may be a considerably large number of EVs being operated in an airport, the improper parking or disposals of EVs on site are causing numerous issues which substantially affect the normal operation of an airport facility.

For instance, the Airport Authority Hong Kong (AAHK) is a key player in EV adoption. There are more than three hundreds electric vehicles, including sedans, vans and electric ground service equipment providing on site services at the Hong Kong International Airport. To support the large number of EVs in services, there are numerous standard charging bays on site for re-energizing these vehicles to keep the same in operation. However, these EVs are currently being operated by a substantive number of individual companies which further increases the difficulties in managing the use of charging bays.

Presently, the parking/charging bays are being monitored manually by human workers which give rise to various management problems to the airport infrastructure. For example, charging bays may be occupied by non-EVs or other types of equipment or vehicle which obstructs the charging port. Further issues such as overdue parking of EVs and the lack of indication on malfunctioning charging bays are practical issues to be imminently addressed in view of the upcoming expansion of parking apron and the implementation of additional runway will be constructed in years ahead.

There arise other issues in relating to the parking of EVs which can be much larger than typical passenger vehicles, whereas in-vehicle optical and ultrasonic sensor systems may not be useful. Therefore, there is a need for a system that automatically and continuously monitors the occupancy of parking/charging bays that required minimal supervision by human workers. It would be also desirable for the above system to provide useful information to the prospective users pertaining to the availability, condition and other vital statistics of EVs via the means of mobile devices and wireless communications.

### SUMMARY OF THE INVENTION

One of the objective of the present invention is thus to provide a system for efficiently monitoring the use of parking or charging bays for EVs which reliably maintains records of registered EVs and their corresponding parking/charging location and other real time data. The use of the system ensures EVs are operated within pre-set policies and rules so that efficiency of EVs operation is enhanced.

Further, another objective of the present invention is to provide a method for detecting obstructions on the parking/charging bays which automatically registers a value in the system without intervention from human worker.

Yet another objective of the present invention is to provide an automatic updating battery simulation model for estimating the remaining charging time of an electric vehicle.

In view of the above objectives, there is provided a parking bay monitoring system for electric vehicles including a main unit for each parking bay, a router being housed in the main unit and connects to a network and at least one digital camera mounted in a position to take digital images of a parking bay. The digital images are transmitted via the router to a central server for analysis by a visual recognition framework to generate a detection result. The system further includes a charging unit, wherein real time data relating to charging is logged and transmitted to the central server. An occupancy status for each parking bay is generated based on the detection result and said data. The system generates a list containing the occupancy status of each parking bay and the said list being accessible by at least one terminal connected to the network.

In an embodiment of the present invention, the at least one terminal accesses the system via the network based on a web platform, and the at least one terminal may be a stationary computer or a mobile device.

In another embodiment of the present invention, the real time data relating to charging may include voltage, current and temperature, etc.

Yet in another embodiment of the present invention, the visual recognition framework detects obstructions on the parking bays using a back-propagation neural network, the visual recognition framework includes a training phase and a detection phase. The training phase comprises processes of selecting multiple images from the camera, defining regions of interest of the images and conducting perspective transform, extracting the regions of interest from the images, extracting histogram of gradient descriptors and hue saturation value descriptors from the images, classifying the images into two groups. The detection phase includes the processes of selecting the multiple images from the training phase, importing features to the back-propagation neural network to obtain a detection result.

In an alternate embodiment of the present invention, the system estimates remaining time of charging by means of equivalent circuit modelling.

In an embodiment of the present invention, the electric vehicles may be electric ground service equipment being operated in an airport which implements the said system.

### BRIEF DESCRIPTION OF THE DRAWINGS

Further characteristics and advantages of the invention will in the following be described in detail by means of the description and by making reference to the drawings which show:

FIG. 1 is a photograph showing the installation of an onsite system at a parking/charging bay according to the present invention;

FIG. 2 is a schematic showing the operation flow of the system in the occurrence of overdue/unauthorized parking according to the present invention;

FIG. 3 is a schematic showing the operation flow of the system in the occurrence of malfunctioning charger according to the present invention;

FIG. 4 is a schematic showing a work flow train phase according to the present invention;

FIG. 5 is a schematic showing a work flow detection phase according to the present invention;

FIG. 6 is a schematic showing an exemplary construction of neural network according to the present invention;

FIG. 7 is a schematic showing a model of back-propagation neural network according to the present invention;

FIG. 8 is a schematic showing an electrical circuit model for battery simulation according to the present invention;

FIG. 9 is a graph showing battery voltage and SOC relationship deduced from the historical data; and

FIG. 10 is a schematic showing mechanism of the estimation of remaining time of charging according to the present invention.

### DESCRIPTION OF PREFERRED EMBODIMENTS

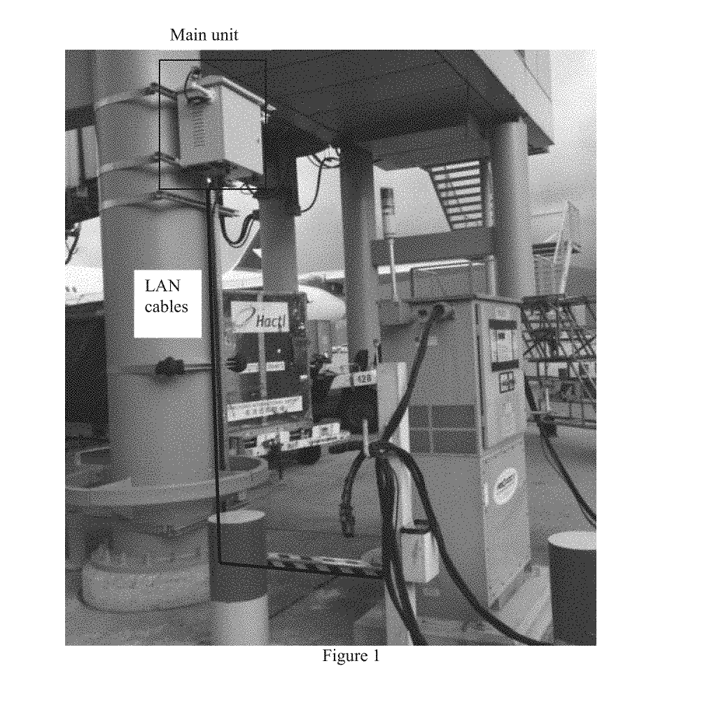

The present invention is exemplified with reference to the schematic drawings in FIGS. 1 to 10. The invention having been disclosed, variations will now be apparent to persons skilled in the art, the system is described as an example only, not to be construed in a limiting way. A description will be given of the structure and operation of the automatic electric ground service equipment parking bay monitoring system according to the preferred embodiment of the present invention with reference to FIG. 1 to FIG. 10.

1. The General Operation Flow of System from Onsite System to Mobile Device

According to the present invention, there is provided an onsite system installed at the location of the parking/charging bay comprising a digital camera and a router housed in a main unit as shown in FIG. 1. The camera takes digital images of the parking/charging bay where the images will be uploaded to a central server through the router inside the main unit of the onsite system. The captured images will subsequently be processed and analyzed.

The captured images are analyzed using a dynamic image processing framework to realize real time detection of occupancy of the parking/charging bay. Through the above system, individual workers may access the captured images and occupancy conditions of the parking/charging bays via an associated web platform using connected terminals.

During the course of charging the EV, the onsite system acquires and uploads relevant data and statistics relating to charging process via the router. The data includes but not limiting to time related information, temperature, voltage and current. Using equivalent circuit modelling, the system can estimate the remaining charging time required to charge the EV to full capacity.

By analyzing the collected data and statistics, the system can show that if any one of the parking/charging bay is occupied by EV and determine its charging condition, i.e., whether the EV is being recharged. If the parking/charging bay is vacant, the system would show that no EV or object is occupying the parking/charging bay and of course, the charger as well. If the above data and statistics indicate that the parking/charging bay are occupied and the charging is in progress, the system will show that an EV is occupying the parking/charging bay and being recharged, and thus the status, i.e., “Occupied”, will be indicated. Furthermore, in the case that the data and statistics show that the parking/charging bay is occupied without the charger in operation, the system will register that the parking/charging bay is being obstructed, which may indicate an occurrence of unauthorized parking of vehicle. Thus, the status, i.e., “Unauthorized Parking”, will be indicated.

In the event that a parking/charging bay is being occupied with statistics showing the battery has been fully charged, the system will register that the EV is fully charged. The status, i.e., “Overdue”, will be indicated for charged EVs that unnecessarily occupy parking/charging bays, if the EV has been idled for a given period of time. Moreover, if any fault signal is received from a particular charger, the system will indicate that the charger is out of order by the status, i.e., “Malfunction”.

With the assistance of auto-detecting the occupancy of parking/charging bay and possible malfunctioning of chargers, workers will be able to report the occurrences of unauthorized parking, overdue parking for any parking/charging bay or malfunctioning of any particular charger via accessing the associated web platform using mobile devices such as tablet computers or smart phones.

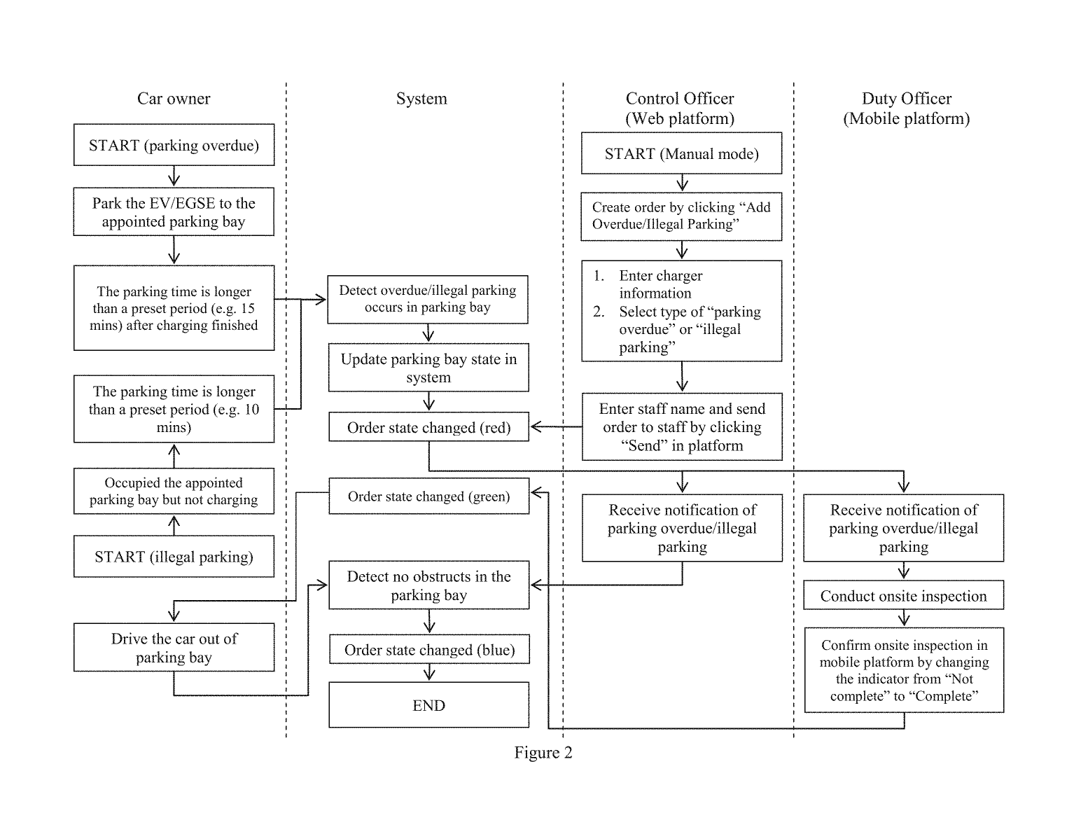

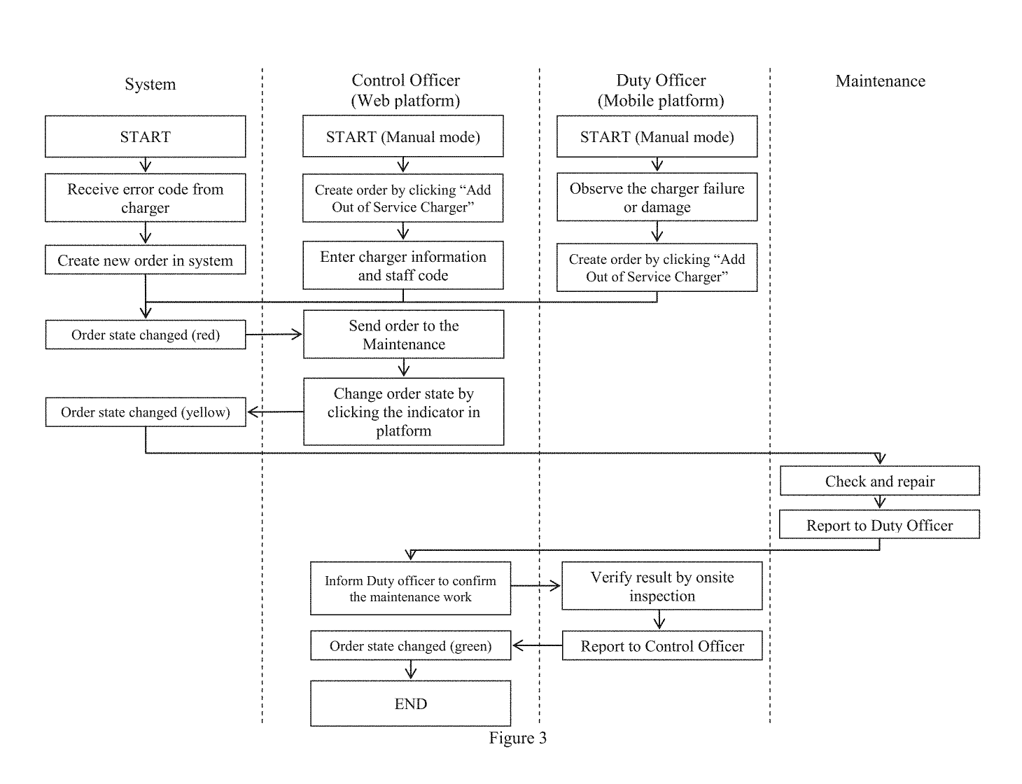

During normal operation of the system, all charging data including estimated remaining charging time, vehicle detection results and occurrences of event, including the occupancy conditions of parking/charging bays and chargers and are uploaded to the web platform. Officers will be able to monitor the statuses of parking/charging bays and chargers online the associated web platform via stationary terminals or mobile devices. Information regarding unauthorized, overdue parking and malfunction of charger may be provided to the relevant officers through the web platform via mobile devices to facilitate the workers to conduct site visits to investigate only when there is an occurrence of above events. Schematics showing the operation flows of the system to detect authorized/overdue parking and malfunctioning of charger are shown in FIG. 2 and FIG. 3 respectively.

2. Dynamic Image Processing Framework for Detecting Obstructions on the Parking/Charging Bay by Using Neural Networks

According to the present invention, there is further provided a dynamic image processing framework for detecting obstructions on the parking/charging bay by using neural networks.

The present invention further proposed a framework to detect obstructions in outdoor parking bay under outdoor condition. This framework may be applied by cameras installed in different positions. The algorithm is low consumption in terms of computation power and makes it ideal for use with cloud computing.

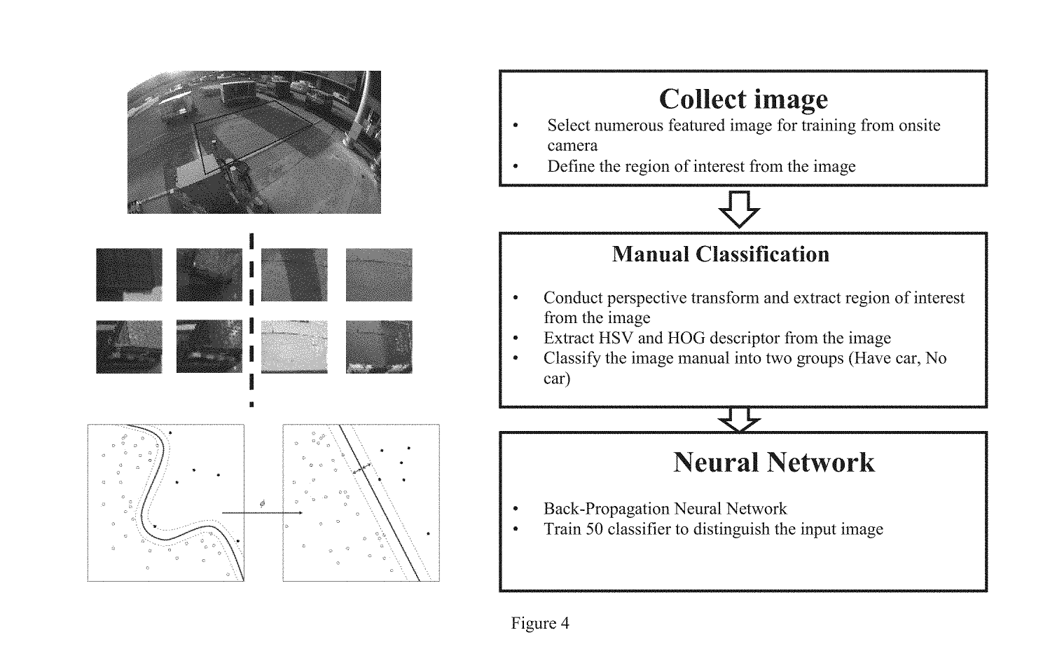

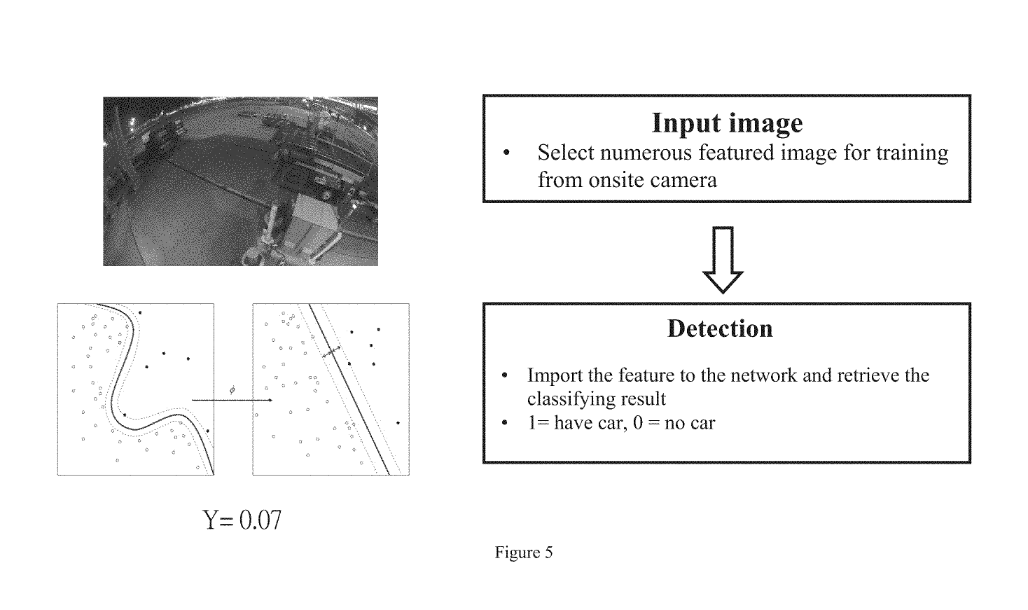

The framework is divided into two phases: training phase and detection phase as shown in FIG. 4 and FIG. 5 respectively.

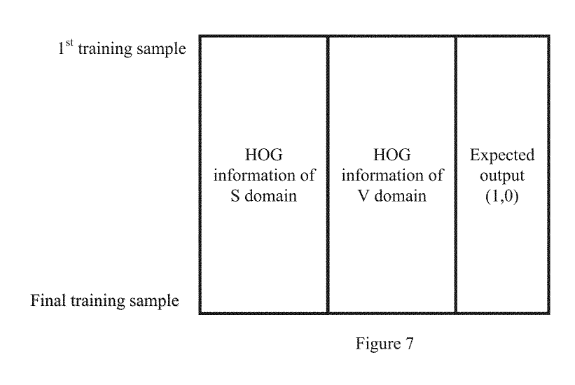

Training Phase
1. Numerous featured images are selected and region of interest (ROI) are selected.
2. Then perspective transformed will be conducted to transform the region ROI to a rectangle, then the HOG descriptor is extracted from the HSV color space of the ROI.
3. A back-propagation neural network will be applied to thousands of pictures. The HOG data of SV domain will be aligned in specified format (FIG. 7) to obtain the model for detection.

Detection Phase
1. The region of interest of image is perspective transformed to rectangle, then the HOG descriptor is extracted from the HSV color space of the ROI.
2. The features will be calculated by the previous obtained model to obtain the detection result.

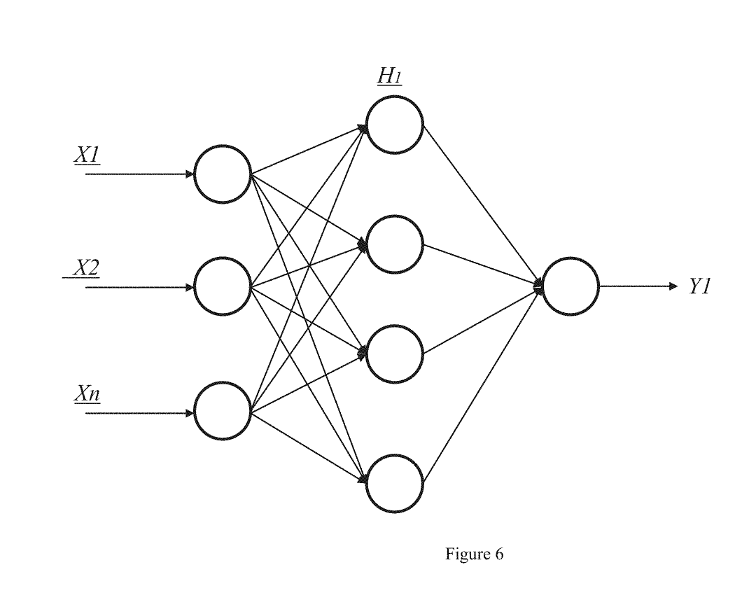

The Alignment of the Back-Propagation Model—One of known feature of the back-propagation network feature is that the response of the trained model varies when using different settings. According to the present invention as shown in FIG. 6, the proposed model has 3024 input layers which are the S and V domain information from the captured image, and 50 hidden layer for the classifier, the output is only a single value (where 1 indicates the existence of obstructs and 0 indicated non-existence of obstructs in parking bay). Over 150 training cycles are conducted to construct the training model. The detailed alignment of the training model is shown in FIG. 7. The experimental result shows that this model could detect obstruct in parking bay with over 98% accuracy.

3. An Automatic Updating Battery Simulation Model for Remaining Charging Time Estimation

The present invention proposed a framework for the System to estimate the remaining charging time of the EGSE. Based on the data measured by the charger such as charging voltage, current, battery state of charge (SOC), equivalent circuit model is used to simulate the electrical behavior of EGSE's battery so as to estimate the remaining charging time of EGSE. In order to reduce the down-time for undergoing prolonged model characterization process, the model parameters of individual EGSE battery would be characterized and updated automatically by least-square curve fitting estimation through the charging sessions during daily operation.

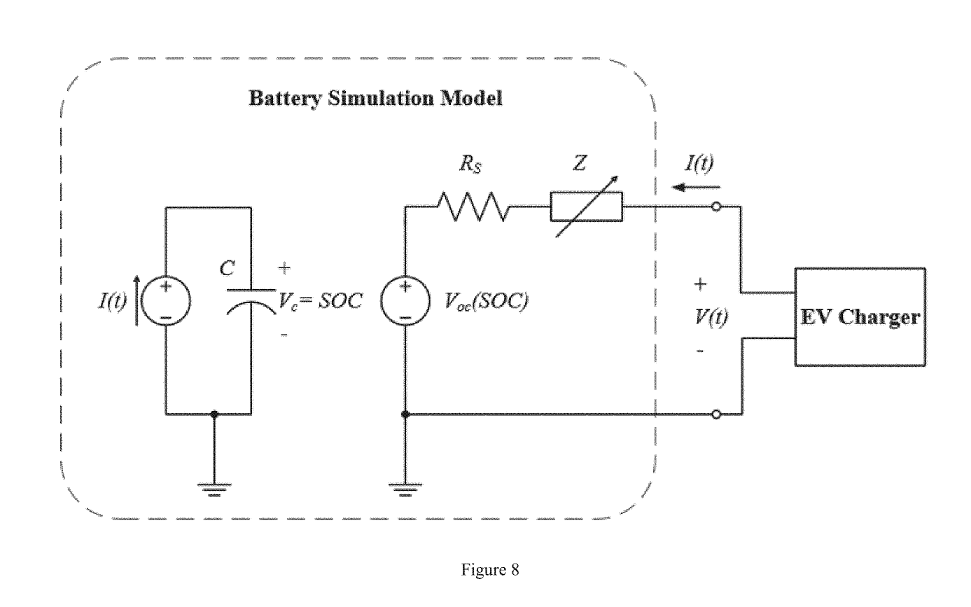

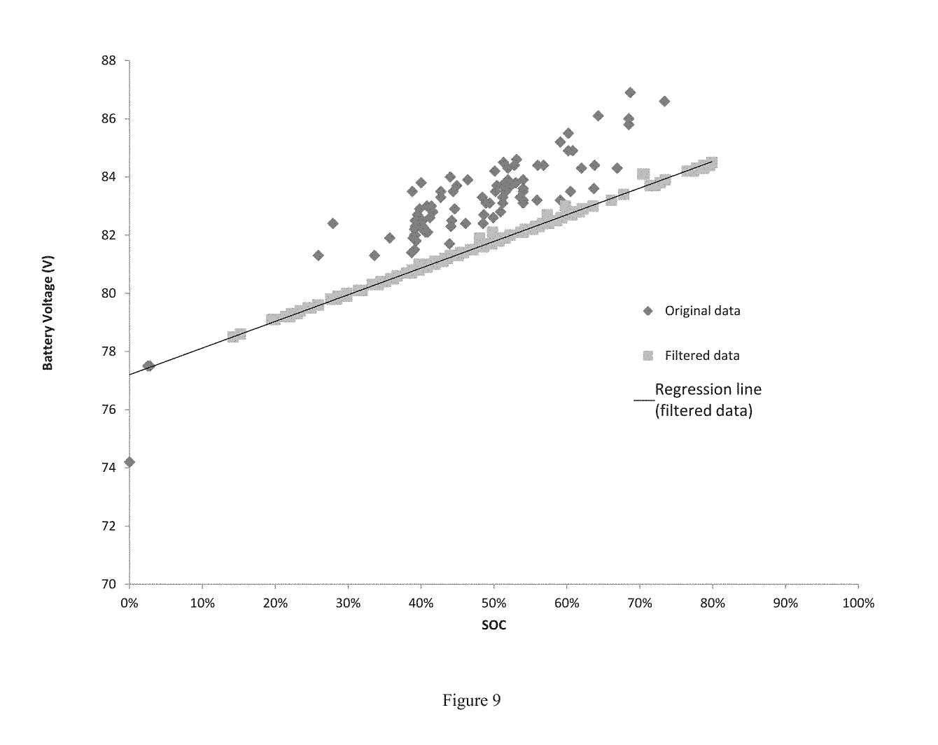

a) Battery Modeling
Considering that the backend application may need to handle the estimation algorithm simultaneously for a number of EGSE charging events, a battery model required less computation effort would be more desirable. Thus electrical circuit model is chosen in this invention. Electrical circuit models are a commonly used way of simulating the behaviors of a battery by an equivalent circuit with a combination of voltage sources, current sources, resistors, capacitors, inductors, or a complex ac-equivalent network. FIG. 8 shows the electrical circuit model used in this invention.
In this invention, a default battery model as shown in FIG. 8 is built first based on the historical data. In the model, charging voltage V(t), current I(t), SOC are provided by the charger. On the other hand, series resistance Rs and the ampere-capacity C of the battery are constants that can be read from the Battery Monitor and Identifier Module (BMID) embedded in the battery.
The remaining elements are: (i) the relationship between Voc and SOC; and (ii) the relationship between impedance Z and SOC.
Conventionally, the relationship between Voc and SOC is acquired via prolonged charging and discharging profiles. In this invention, this relationship is extracted based on the start and end conditions of a large number of charging sessions from various EGSE to come up with a pseudo relationship.
The plot shown in FIG. 9 illustrates the start voltage and end voltage against SOC. A relatively linear characteristic is exhibited by the red data dots. This linear characteristic is consistent with general Lead-Acid battery used in EGSE. The blue data dots are likely due to that the voltage is not yet return to equilibrium state or from other battery type(s) which has more cells in series, thus higher voltage were measured. In this invention, it is modeled by a linear equation:

V_oc=m*SOC+c Eq. 1
Parameters m & c are extracted by the method of linear regression with the Voc and SOC data. There are different types of EGSE, of which the number of cells might be different. To cater this circumstance, Eq. 1 is normalized with respect to the number of cells during parameter identification.
The relationship between the non-linear impedance and SOC is identified through the charging profile. A dual-exponential function as shown in Eq. 2 is used to model the relationship between Z and SOC,

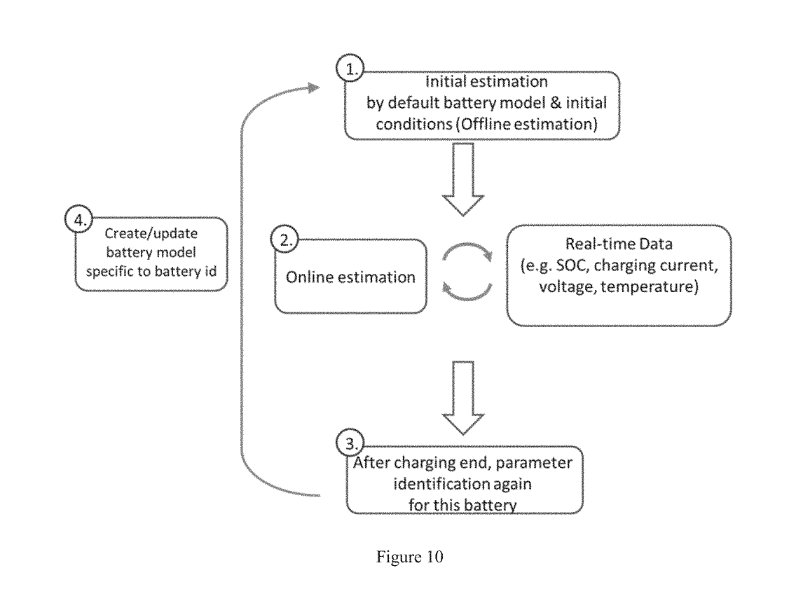

Z=a·ê(b·SOC)+c·ê(d·SOC) Eq. 2
By least-square curve fitting process, the four parameters a, b, c, d can be identified. One set of charging profile is recorded for extracting the model parameters, which are used to construct the default battery model.
The default model is the base of the framework. The remaining charging time estimation can be achieved by four steps as shown in FIG. 10.

b) Mechanism of Remaining Charging Time Estimation
Step 1 Initial estimation is the use of default battery model & initial conditions to perform remaining charging time estimation (offline estimation).
Once the charger is connected to the battery of the EGSE, the system will check the database if there is a battery model corresponding to this battery ID. If it does, its own battery model is used for the estimation, otherwise, the default model is used.
The estimated remaining charging time is the sum of two parts i) constant current charging time and ii) constant voltage charging time.
In the constant current charging period, constant charging current set by the charger and initial SOC are input to the battery model for simulation until the simulated SOC at which the charger switches to constant voltage charging. The time for the constant current charging period is then simulated.
In the constant voltage charging period, constant charging voltage set by the charger and the SOC at which the charger switches to constant voltage charge. By running the simulation until the end of charge conditions are reached, the time for constant voltage charge can be obtained.
The overall remaining charging is simply the sum of constant current charging time and constant voltage charging time.
Step 2 Online Estimation is similar to Step 1 (initial estimation), except that the measured current, measured voltage and real-time SOC from the charger are used for estimation. It is inevitably that the measured current and voltage values fluctuate due to measurement noise and charger's capability of the charging profile control. This would result in fluctuation of remaining time and lead to poor used experience. For practical reason, this invention uses a timer to countdown from the estimation, and update the remaining charging time at a regular interval (e.g. per 5 minutes).
Step 3 is the Parameter Identification, which is performed after the end of the charging session. The complete charging profiles (measured charging current, measured charging voltage and SOC) will be used to extract the parameters of the model. The procedures are similar to those for building the default model.
Step 4 is to update the identified parameter values to the battery model corresponding to the EGSE battery just completed charging. The parameter values are also stored in the database and can be retrieved during next charging session.
By such 4-step mechanism, the battery model can be built automatically and the remaining time estimation can be performed without the interruption of the EGSE daily operation.

The foregoing description of the preferred embodiment of the invention has been presented for the purposes of illustration and description. The above embodiments of the present invention have been given as examples, illustrative of the principles of the present invention. It is not intended to be exhaustive or to limit the invention to the precise form disclosed.

Variations of the apparatus and method will be apparent to those skilled in the art upon reading the present disclosure. These variations are to be included in the spirit of the present invention. It is intended that the scope of the invention be limited not by this detailed description, but rather by the intended scope of claims. Since many embodiments of the invention can be made without departing from the spirit and scope of the invention, the invention resides in the claims hereinafter appended.

1. A parking bay monitoring system for electric vehicles, comprising:
a main unit for each parking bay;
a router being housed in the main unit and connects to a network;
at least one digital camera mounted in a position to take digital images of a parking bay, wherein the digital images are transmitted via the router to a central server for analysis by a visual recognition framework to generate a detection result, and
a charging unit, wherein real time data relating to charging is logged and transmitted to the central server, and an occupancy status for each parking bay is generated based on the detection result and said data,
wherein the system generates a list containing the occupancy status of each parking bay and the list being accessible by at least one terminal connected to the network.

2. The parking bay monitoring system according to claim 1, wherein the at least one terminal accesses the system via the network based on a web platform.

3. The parking bay monitoring system according to claim 2, wherein the at least one terminal may be a stationary computer.

4. The parking bay monitoring system according to claim 2, wherein the at least one terminal may be a mobile device.

5. The parking bay monitoring system according to claim 1, wherein real time data relating to charging includes, voltage, current and temperature.

6. The parking bay monitoring system according to claim 1, wherein visual recognition framework detects obstructions on the parking bays using a back-propagation neural network, the visual recognition framework comprises a training phase and a detection phase.

7. The parking bay monitoring system according to claim 6, wherein the training phase comprises processes of selecting multiple images from the camera, defining regions of interest of the images and conducting perspective transform, extracting the regions of interest from the images, extracting histogram of gradient descriptors and hue saturation value descriptors from the images, classifying the images into two groups.

8. The parking bay monitoring system according to claim 7, wherein the detection phase comprises the processes of selecting the multiple images from the training phase, importing features to the back-propagation neural network to obtain a detection result.

9. The parking bay monitoring system according to claim 1, wherein the system estimates remaining time of charging by means of equivalent circuit modelling.

10. The parking bay monitoring system according to claim 1, wherein the electric vehicles may be electric ground service equipment.

11. The parking bay monitoring system according to claim 1, wherein the occupancy status may be occupied, unauthorized parking, overdue or malfunction.

12. The parking bay monitoring system according to claim 1, wherein the said system is implemented in an airport.
